(19) United States
(12) Patent Application Publication
(10) Pub. No.: US 2015/0159719 A1
(43) Pub. Date: Jun. 11, 2015

(54) ISOLATOR

(71) Applicant: LORD Corporation, Cary, NC (US)

(72) Inventors: Donald D. Russell, Fairview, PA (US); Adam S. Gilmore, Erie, PA (US); Gregg Cune, Conroe, TX (US); Samuel O. Caraballo, Erie, PA (US); John P. Smid, Fairview, PA (US)

(21) Appl. No.: 14/409,182

(22) PCT Filed: Aug. 2, 2013
(86) PCT No.: PCT/US2013/053418

§ 371 Date: Dec. 18, 2014

Related U.S. Application Data
(60) Provisional application No. 61/679,263, filed on Aug. 3, 2012.
(60) Provisional application No. 61/782,235, filed on Mar. 14, 2013.

(51) Int. Cl. F16F 1/36; F16F 1/50

(52) U.S. Cl. CPC F16F 1/3605; F16F 1/50

(57) ABSTRACT

An isolator has a force input component, a force output component, a first shear unit connected between the force input component, and a second shear unit connected between the force output component, wherein the first shear unit and the second shear unit are connected in series with each other along a force path between the force input component and the force output component.

### CROSS REFERENCE TO RELATED APPLICATION

This application relates to and claims priority to U.S. Provisional Patent Application Ser. No. 61/782,235, filed Mar. 14, 2013, and this application claim priority to U.S. Provisional Patent Application Ser. No. 61/679,263, filed Aug. 3, 2012, the disclosures of which are both incorporated by reference herein in their entirety.

### BACKGROUND

In some hydrocarbon recovery systems, electronics and/or other sensitive hardware may be included in a drill string. In some cases, a drill string may be exposed to both repetitive vibrations comprising a relatively consistent frequency and vibratory shocks that may not be repetitive. Each of the repetitive vibrations and shock vibrations may damage and/or otherwise interfere with operation of the electronics, such as, but not limited to, measurement while drilling (MWD) devices and/or logging while drilling (LWD) devices, and/or any other vibration sensitive device of a drill string. While some electronic devices are packaged in vibration resistant housings, in some cases the vibration resistant housings are not capable of protecting the electronic devices against both the repetitive and shock vibrations. In some cases, active vibration isolation systems are provided to isolate the electronics from harmful vibration but the active vibration isolation systems are expensive.

### SUMMARY

In some embodiments of the disclosure, an isolator is disclosed as comprising a force input component, a force output component, a first shear unit connected between the force input component, and a second shear unit connected between the force output component, wherein the first shear unit and the second shear unit are connected in series with each other along a force path between the force input component and the force output component.

In other embodiments of the disclosure, a hydrocarbon recovery system is disclosed as comprising a first isolated mass, a first excitation force source component, and a first isolator disposed between the first isolated mass and the first excitation force source component. The first isolator is disclosed as comprising a force input component, a force output component, a first shear unit connected between the force input component and the force output component, and a second shear unit connected between the force input component and the force output component, wherein the first shear unit and the second shear unit are connected in series with each other along a force path between the force input component and the force output component.

In yet other embodiments of the disclosure, a method of isolating a component of a device is disclosed as comprising selecting an excitation frequency associated with operation of a first excitation force source component, providing a spring mass system comprising a first isolated mass and an isolator, the spring mass system comprising a natural frequency less than the selected excitation frequency, and disposing the isolator between the isolated mass and the first excitation force source component.

### BRIEF DESCRIPTION OF THE DRAWINGS

For a more complete understanding of the present disclosure and the advantages thereof, reference is now made to the following brief description, taken in connection with the accompanying drawings and detailed description:

FIG. 1 is a schematic view of a hydrocarbon recovery system according to an embodiment of the disclosure;

FIG. 2 is an orthogonal side view of an isolator of the hydrocarbon recovery system of FIG. 1;

FIG. 3 is an orthogonal side view of the isolator of FIG. 2 with selected components removed to show relatively more radially located internal components;

FIG. 4 is an orthogonal cut-away view of the isolator of FIG. 2;

FIG. 5 is an oblique bottom view of a top adapter of the isolator of FIG. 2;

FIG. 6 is an oblique top view of a top sleeve of the isolator of FIG. 2;

FIG. 7 is an oblique bottom view of a bottom sleeve of the isolator of FIG. 2;

FIG. 8 is an oblique top view of a bottom adapter of the isolator of FIG. 2;

FIG. 9 is an oblique view of a retainer of the isolator of FIG. 2;

FIG. 10 is an oblique view of a shear unit of the isolator of FIG. 2;

FIG. 11 is an oblique view of a mandrel of the isolator of FIG. 2;

FIG. 12 is a chart showing a transmissibility versus exciting frequency curve of the isolator of FIG. 2;

FIG. 13 is a chart showing a response acceleration versus time curve of the isolator of FIG. 2;

FIG. 14 is an orthogonal side view of an isolator according to another embodiment of the disclosure;

FIG. 15 is an orthogonal side cut-away view of the isolator of FIG. 14;

FIG. 16 is a schematic cut-away side view of an isolator according to another embodiment of the disclosure; and

FIG. 17 is a schematic view of a hydrocarbon recovery system according to an alternative embodiment of the disclosure.

### DETAILED DESCRIPTION

In some cases, it may be desirable to provide a passive isolator for a drill string that protects electronics and/or other sensitive equipment form repetitive vibrations and/or shock vibrations. It may be desirable to provide an isolator configured to axially isolate the above-described vibration sensitive components from vibrations over a large frequency range. In some cases, an isolator may be tuned and/or otherwise configured to isolate the vibration sensitive component from frequencies as low as about 1 Hz to about 50 Hz, about 5 Hz to about 25 Hz, about 10 Hz to about 20 Hz, or about 15 Hz. In some embodiments, even though an isolator is configured to effectively isolate the above-described relatively low frequencies, the same isolators may also effectively isolate the vibration sensitive components from frequencies much higher, such as hundreds and/or even thousands of Hertz. In other words, an isolator configured to protect vibration sensitive components from low frequency vibrations may also protect vibration sensitive components from high frequency vibrations. In some embodiments of the disclosure, systems and methods are disclosed that comprise providing an isolator comprising a passive and relatively soft (i.e. relatively long settling time) spring-mass system configured to have a natural frequency less than 0.7 times a selected anticipated excitation frequency. In some embodiments, the above-described isolator may comprise two or more axial displacement elements, each of which provide force transmission paths in series with each other and each of which are axially movable to selectively alter an overall length of the isolator in response to a vibratory and/or shock input to the isolator.

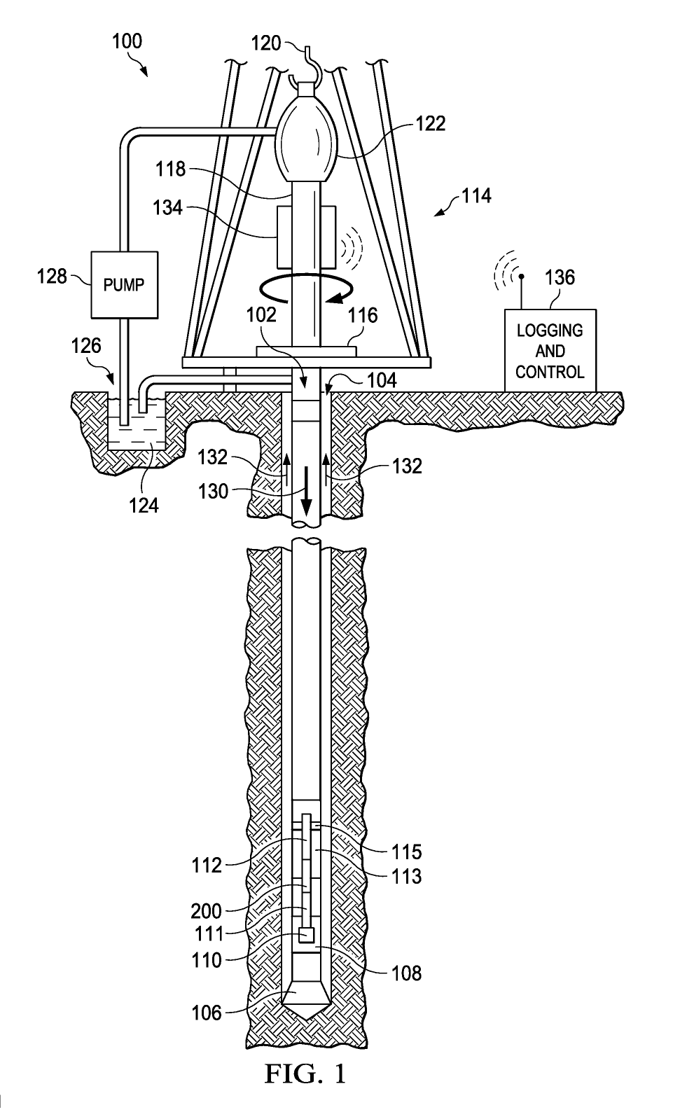

Referring now to FIG. 1, a schematic view of a hydrocarbon recovery system 100 is shown. The hydrocarbon recovery system 100 may be onshore or offshore. They hydrocarbon recovery system 100 generally comprises a drill string 102 suspended within a borehole 104. The drill string 102 comprises a drill bit 106 at the lower end of the drill string 102 and a universal bottom hole orienting (UBHO) sub 108 connected above the drill bit 106. The UBHO sub 108 comprises a mule shoe 110 configured to connect with a stinger or pulser helix 111 on a top side of the mule shoe 110. The hydrocarbon recovery system 100 further comprises an electronics casing 113 connected to a top side of the UBHO sub 108. The electronics casing 113 may at least partially house the stinger or pulser helix 111, an isolator 200 connected above the stinger or pulser helix 111, electronic components 112 connected above the isolator 200, and/or centralizers 115. The hydrocarbon recovery system 100 comprises a platform and derrick assembly 114 positioned over the borehole 104 at the surface. The derrick assembly 114 comprises a rotary table 116 which engages a kelly 118 at an upper end of the drill string 102 to impart rotation to the drill string 102. The drill string 102 is suspended from a hook 120 that is attached to a traveling block. The drill string 102 is positioned through the kelly 118 and the rotary swivel 122 which permits rotation of the drill string 102 relative to the hook 120. Additionally or alternatively, a top drive system may be used to impart rotation to the drill string 102.

In some cases, the hydrocarbon recovery system 100 further comprises drilling fluid 124 which may comprise a water-based mud, an oil-based mud, a gaseous drilling fluid, water, gas and/or any other suitable fluid for maintaining bore pressure and/or removing cuttings from the area surrounding the drill bit 106. Some drilling fluid 124 may be stored in a pit 126 and a pump 128 may deliver the drilling fluid 124 to the interior of the drill string 102 via a port in the rotary swivel 122, causing the drilling fluid 124 to flow downwardly through the drill string 102 as indicated by directional arrow 130. The drilling fluid 124 may pass through an annular space between the electronics casing 113 and each of the pulser helix 111, the isolator 200, and/or the electronic components 112 prior to exiting the UBHO sub 108. After exiting the UBHO sub 108, the drilling fluid 124 may exit the drill string 102 via ports in the drill bit 106 and circulate upwardly through the annulus region between the outside of the drill string 102 and the wall of the borehole 104 as indicated by directional arrows 132. The drilling fluid 124 may lubricate the drill bit 106, carry cuttings from the formation up to the surface as it is returned to the pit 126 for recirculation, and create a mudcake layer (e.g., filter cake) on the walls of the borehole 104. In some embodiments, the hydrocarbon recovery system 100 may further comprise an agitator and/or any other vibratory device configured to vibrate, shake, and/or otherwise change a position of an end of the drill string 102 and/or any other component of the drill string 102 relative to the wall of the borehole 104. In some cases, operation of an agitator may generate oscillatory movement of selected portions of the drill string 102 so that the drill string 102 is less likely to become hung or otherwise prevented from advancement into and/or out of the borehole 104. In some embodiments, low frequency oscillations of the agitator may have values of about 5 Hz to about 100 Hz.

The hydrocarbon recovery system 100 further comprises a communications relay 134 and a logging and control processor 136. The communications relay 134 may receive information and/or data from sensors, transmitters, and/or receivers located within the electronic components 112 and/or other communicating devices. The information may be received by the communications relay 134 via a wired communication path through the drill string 102 and/or via a wireless communication path. The communications relay 134 may transmit the received information and/or data to the logging and control processor 134 and the communications relay 134 may receive data and/or information from the logging and control processor 136. Upon receiving the data and/or information, the communications relay 134 may forward the data and/or information to the appropriate sensor(s), transmitter(s), and/or receiver(s) of the electronic components 112 and/or other communicating devices. The electronic components 112 may comprise measuring while drilling (MWD) and/or logging while drilling (LWD) devices and the electronic components 112 may be provided in multiple tools or subs and/or a single tool and/or sub. In alternative embodiments, different conveyance types including, for example, coiled tubing, wireline, wired drill pipe, and/or any other suitable conveyance type may be utilized.

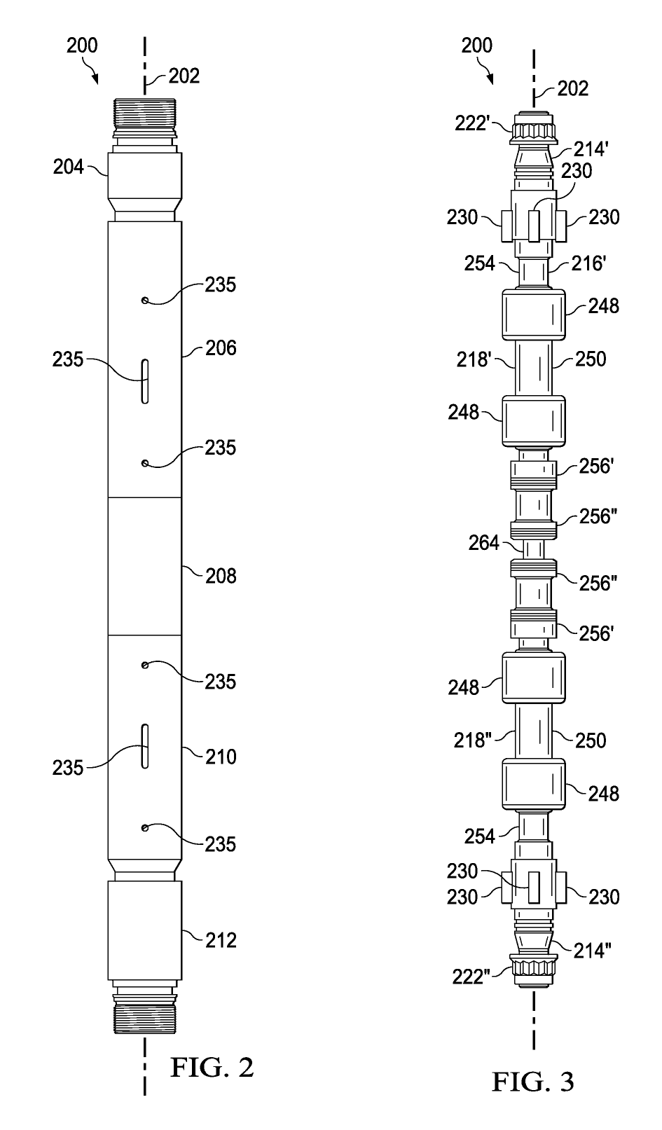

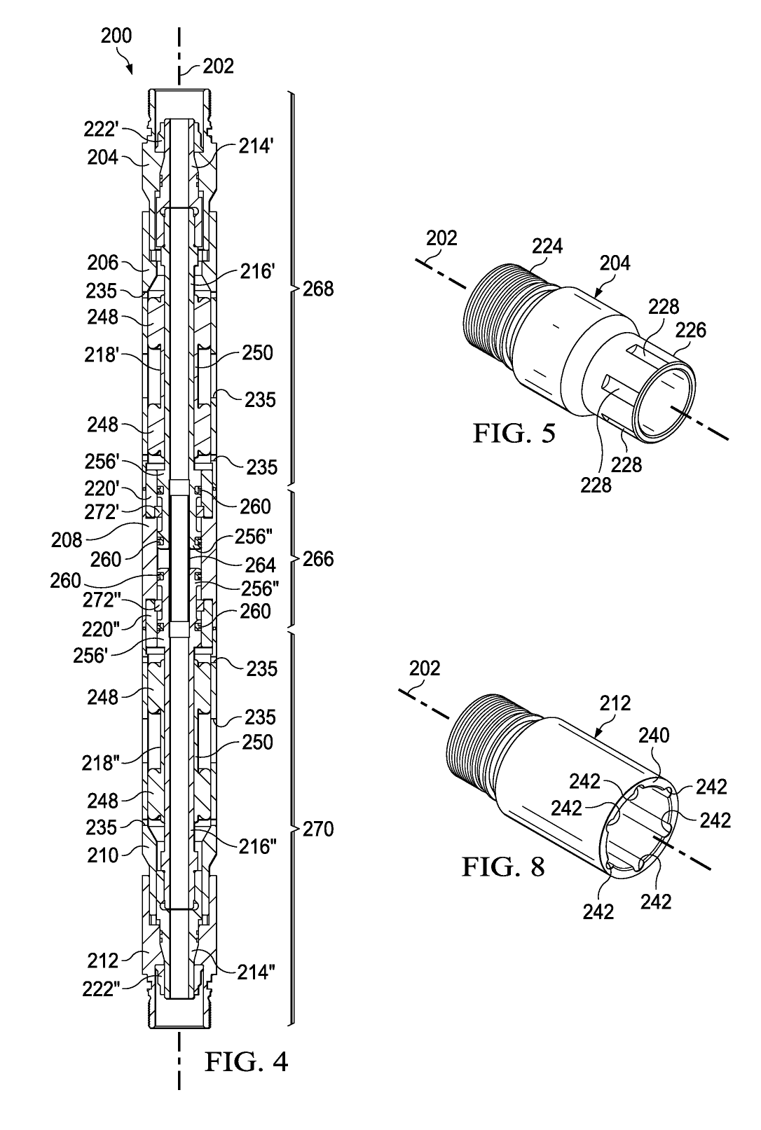

Referring now to FIGS. 2-4, an orthogonal side view, an orthogonal side view with selected exterior components removed, and an orthogonal cut-away side view of the isolator 200 are shown, respectively. The isolator 200 generally comprises a central axis 202 with which many of the components of the isolator 200 are substantially aligned coaxially. Referring primarily to FIGS. 2 and 4, the isolator 200 comprises an upper adapter 204, an upper sleeve 206, a central joint 208, a lower sleeve 210, and a lower adapter 212, each of which are generally exterior components. Referring primarily to FIGS. 3 and 4 (where each of the upper adapter 204, the upper sleeve 206, the central joint 208, the lower sleeve 210, and the lower adapter 212 are hidden in FIG. 3), the isolator 200 further comprises two adapter interfaces 214 (an upper adapter interface 214′ and a lower adapter interface 214″), two mandrels 216 (an upper mandrel interface 216′ and a lower mandrel 216″), two shear units 218 (an upper shear unit 218′ and a lower shear unit 218″), two joint rings 220 (an upper joint ring 220′ and a lower joint ring 220″), and two locking nuts 222 (an upper locking nut 222′ and a lower locking nut 222″).

Referring now to FIG. 5, an oblique bottom view of the upper adapter 204 is shown. The upper adapter 204 comprises a threaded drill string interface 224 for selective threaded attachment to other components of a drill string 102, an interior travel tube 226, and a plurality of concavities 228 formed on an exterior surface of the interior travel tube 226. Each of the concavities 228 is configured to receive a portion of a cylindrical pin 230 (see FIG. 3).

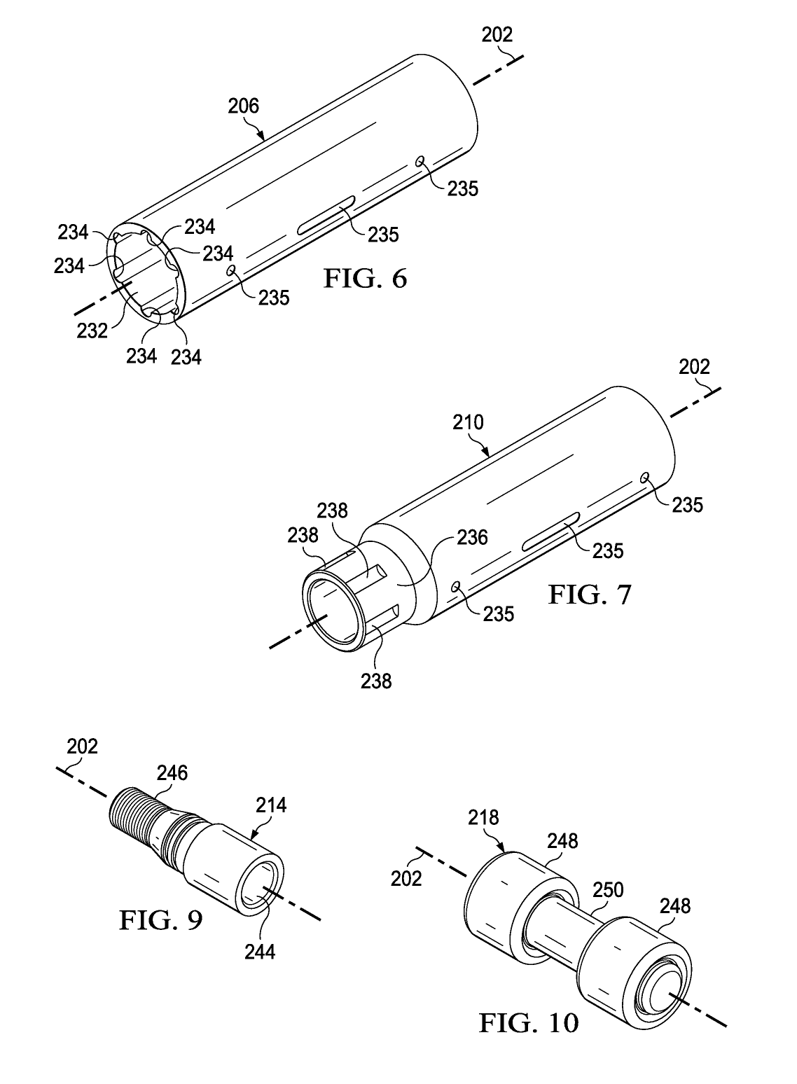

Referring now to FIG. 6, an oblique top view of the upper sleeve 206 is shown. The upper sleeve 206 comprises an exterior travel tube 232 and a plurality of concavities 234 formed on an interior surface of the exterior travel tube 232. Each of the concavities 234 is configured to receive a portion of a cylindrical pin 230 (see FIG. 3). When the cylindrical pins 230 are disposed between the upper adapter 204 and upper sleeve 206 and within the concavities 228, 234, the cylindrical pins 230 serve to prevent axial rotation of the upper adapter 204 relative to the upper sleeve 206. The upper sleeve 206 further comprises apertures 235 (i.e. holes and/or slots) suitable for allow drilling fluids 124 to pass through and equalize fluid pressures within the upper sleeve 206 relative to fluid pressures outside of the upper sleeve 206.

Referring now to FIG. 7, an oblique bottom view of the lower sleeve 210 is shown. The lower sleeve 210 comprises an interior travel tube 236 and a plurality of concavities 238 formed on an exterior surface of the internal travel tube 236. Each of the concavities 238 is configured to receive a portion of a cylindrical pin 230 (see FIG. 3). The lower sleeve 210 further comprises apertures 235 suitable for allow drilling fluids 124 to pass through and equalize fluid pressures within the lower sleeve 210 relative to fluid pressures outside of the lower sleeve 210.

Referring now to FIG. 8, an oblique top view of the lower adapter 212 is shown. The lower adapter comprises an exterior travel tube 240 and a plurality of concavities 242 formed on an interior surface of the exterior travel tube 240. Each of the concavities 242 is configured to receive a portion of a cylindrical pin 230 (see FIG. 3). When the cylindrical pins 230 are disposed between the lower adapter 212 and lower sleeve 210 and within the concavities 242, 238, the cylindrical pins 230 serve to prevent axial rotation of the lower adapter 212 relative to the lower sleeve 210.

Referring now to FIG. 9, an oblique view of the adapter interface 214 is shown. The adapter interface comprises an interior threaded interface 244 and an exterior threaded interface 246.

Referring now to FIG. 10, an oblique view of the shear unit 218 is shown. The shear unit 218 generally comprises two shear elements 248 joined together by a shear shaft 250. In this embodiment, the shear elements 248 and shear shaft 250 are integrally formed of an elastomeric material, such as, but not limited to, rubber (e.g., nature rubber) and/or nitrile. In alternative embodiments, one or more portions of the shear unit 218 may comprise any other suitable elastically deformable material and/or composite structure. In alternative embodiments, the shear elements 248 and/or the shear shaft 250 may comprise dissimilar shear moduli so that the force required to shear one portion of the shear unit 218 may be insufficient to shear another portion of the shear unit so that the shear unit 218 may provide a non-linear and/or a tiered response to shearing forces generally parallel to the central axis 202. By increasing a distance between the shear elements 248, the shear elements 248 may increasingly prevent cocking and/or off axis alignment of the mandrel 216′ relative to the upper sleeve 206 and/or the mandrel 216″ relative to the lower sleeve 210.

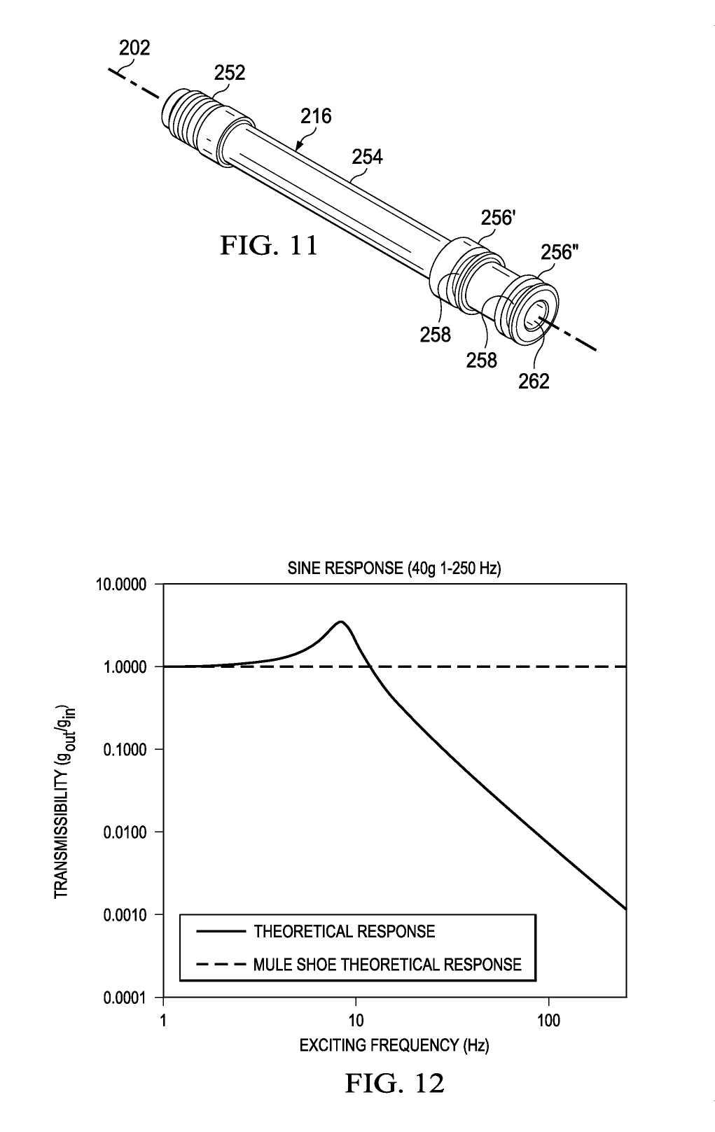

Referring now to FIG. 11, an oblique view of the mandrel 216 is shown. The mandrel 216 comprises a threaded interface 252, a carrier tube 254, and a plurality of collars 256 comprising outer diameters greater than the outer diameter of the carrier tube 254. The collars 256 each comprise a circumferential seal recess 258 for receiving a circumferential seal 260 (see FIG. 4). One of the collars 256 is an outer collar 256′ while another one of the collars 256 is an inner collar 256″. In some embodiments, the seals 260 may comprise T-seals. The mandrel 216 further comprises a receiver hole 262 configured to receive at least a portion of a pin tube 264 (see FIG. 4).

Referring primarily back to FIGS. 2-4, an initial portion of assembling the isolator 200 may be accomplished by assembling a central portion 266, an upper portion 268, and a lower portion 270 (see FIG. 4). Assembly of the central portion 266 comprises disposing the pin tube 264 within the interior of the central joint 208. Next, each of the ends of the mandrels 216 with receiver holes 262 may be slid into the interior of the central joint 208 and the pin tube 264 may be received within each of the receiver holes 262. Next, stop rings 272 may be disposed on recessed shelves of joint rings 220. Next, exterior threaded interfaces of the joint rings 220 may be mated to internal threaded interfaces of the central joint 208, thereby capturing the most centrally located inner collars 256″ within the central joint 208 and relatively more central than the stop rings 272. When the isolator 200 is fully compressed in response to compressive input forces, the outer collars 256′ press against the stop rings 272 toward a center of the central joint 208. When the isolator 200 is fully extended in response to tension input forces, the inner collars 256″ press against the stop rings 272 in a direction away from the center of the central joint 208. Accordingly, in the case of a failure of the shear unit 218, the movable components of the isolator do not separate from each other, but rather, remains connected to each other in a manner that allow removal by fishing techniques. Next, and/or previously, the shear units 218 may be connected to and/or adhered to the carrier tubes 254 of the mandrels 216.

Assembly of the upper portion 268 comprises sliding upper mandrel 216′ into the upper sleeve 206 and mating an internal threaded interface of the upper sleeve 206 to an external threaded interface of the upper joint ring 220′. In some embodiments, the interior of the upper sleeve 206 may be prepared with adhesive and/or other axially locking elements for interfacing with and axially retaining an outer wall of the shear elements 248 of the upper mandrel 216′ to the interior surface of the upper sleeve 206. Next, the interior threaded interface 244 of the upper adapter interface 214′ may be mated with the threaded interfaced 252 of the upper mandrel 216′. The upper portion 268 may be secured to the central portion 266 by inserting the upper locking nut 222′ into the upper adapter 204 and by mating the upper locking nut 222′ to the exterior threaded interface 246 of the upper adapter interface 214′.

Assembly of the lower portion 270 comprises sliding lower mandrel 216″ into the lower sleeve 210 and mating an internal threaded interface of the lower sleeve 210 to an external threaded interface of the lower joint ring 220″. In some embodiments, the interior of the lower sleeve 210 may be prepared with adhesive and/or other axially locking elements for interfacing with and axially retaining an outer wall of the shear elements 248 of the lower mandrel 216″ to the interior surface of the lower sleeve 210. Next, the interior threaded interface 244 of the lower adapter interface 214″ may be mated with the threaded interfaced 252 of the lower mandrel 216″. The lower portion 270 may be secured to the central portion 266 by inserting the lower locking nut 222″ into the lower adapter 212 and by mating the lower locking nut 222″ to the exterior threaded interface 246 of the lower adapter interface 214″.

In operation, the isolator 200 when coupled with a mass to be isolated (i.e. electronic components 112 and/or more generally an isolated mass) provides a relatively soft (relatively long settling time) spring mass system that operates to isolate the electronic components 112 from selected frequencies of vibrational perturbations. While in some embodiments, the isolated mass (i.e. the electronic components 112) may weigh about 150 pounds, in alternative embodiments, the electronic components 112 and/or any other components that together comprise a mass to be isolated by the isolator 200 may comprise any other suitable weight. Each of the In particular, the isolator 200 receives perturbing axial input forces (e.g. compressive forces and/or tension forces) from the spacer 110 and transfers the forces to the lower adapter 212. The force is transferred from the lower adapter 212 to the lower mandrel 216″ via the lower adapter interface 214″. The force is transferred from the lower mandrel 216″ to the lower sleeve 210 via the relatively flexible lower shear unit 218″. To the extent that the shear unit 218″ allows axial displacement of the lower mandrel 216″, the lower mandrel 216″ is free to displace in response to the input forces within the central joint 208 until one of the collars 256 interfere with the lower stop ring 272″. The force is further transferred from the lower sleeve 210 to the upper sleeve 206 via the central joint 208. The force is then transferred from the upper sleeve 206 to the upper mandrel 216′ via the upper shear unit 218′.

Flexure of the upper shear unit 218′ results in movement of the upper sleeve 206 either toward or away from the electronic components 112, depending on the axial direction and magnitude of the input forces. Accordingly, sufficient upward or compressive forces applied to the lower adapter 212 result in at least one of (1) foreshortening of a combined overall length of the lower adapter 212 and the lower sleeve 210 by displacing the lower adapter 212 and the lower mandrel 216″ closer to the central joint 208 and (2) foreshortening of a combined overall length of the upper adapter 204 and the upper sleeve 206 by displacing the upper sleeve 206 closer to the upper adapter 204. Similarly, sufficient downward or tension forces applied to the lower adapter 212 result in at least one of (1) lengthening of a combined overall length of the lower adapter 212 and the lower sleeve 210 by displacing the lower adapter 212 and the lower mandrel 216″ away from the central joint 208 and (2) lengthening of a combined overall length of the upper adapter 204 and the upper sleeve 206 by displacing the upper sleeve 206 away from the upper adapter 204. The above-described force transfer path between the lower adapter 212 and the upper adapter 204 comprises two serially connected soft transfer paths, each comprising a shear unit 218.

Referring now to FIG. 12, a chart 300 of a sine response of the isolator 200 is illustrated. Particularly, the chart 300 shows that a transmissibility of forces versus excitation frequency. In this embodiment, the natural frequency of the spring mass system comprising the isolator 200 is slightly less than 10 Hz. As such, when excitation forces of about 10 Hz are applied to the isolator 200, the forces are amplified. However, as frequency increases and the spring mass system passes through resonance at the spring mass system natural frequency, the amplification of the forces begins to decrease. Once the excitation frequency exceeds 1.4 times the natural frequency of the spring mass system, the isolator 200 is considered to be providing isolation for the electronic components 112. The chart 300 shows that as the excitation frequency increases well beyond 1.4 times the natural frequency of the spring mass system, the isolator 200 becomes even more effective at reducing transmission of forces from the spacer 110 to the electronic components 112.

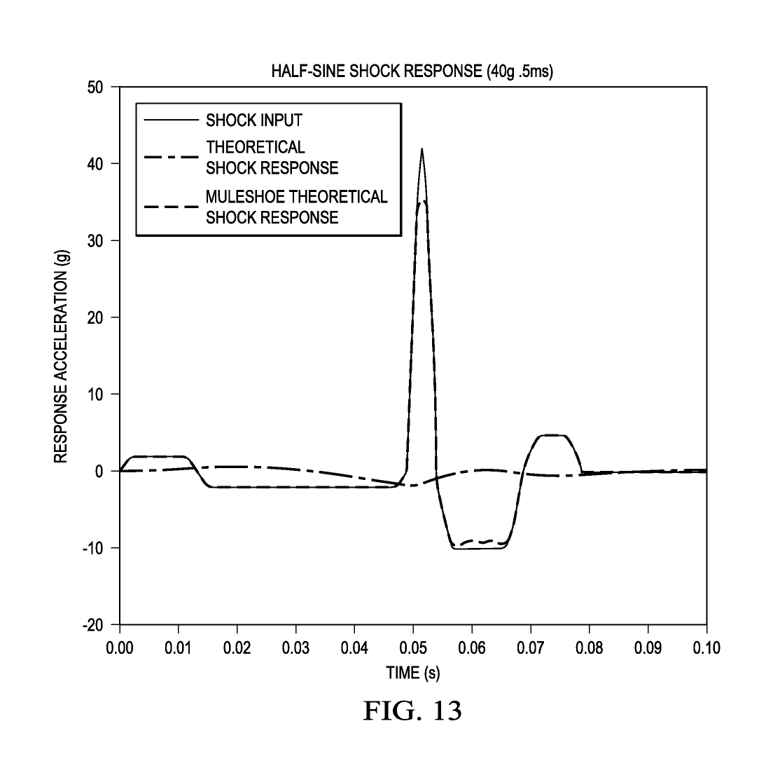

Referring now to FIG. 13, a chart 400 of a half-sine response of the isolator 200 is illustrated. Particularly, the chart 400 shows that when a 40G shock excitation force is applied to the isolator at 0.5 ms, the shock response actually transferred through the isolator (i.e. passed on to the electronic components 112) is relatively stable and comprises a maximum absolute value of about 2G. Because the frequency ratio of the natural frequency of the spring mass system to the shock driving frequency is very low, shock attenuation is attained. If the damping characteristics of the isolator 200 were increased, a maximum amplification factor would be further decreased.

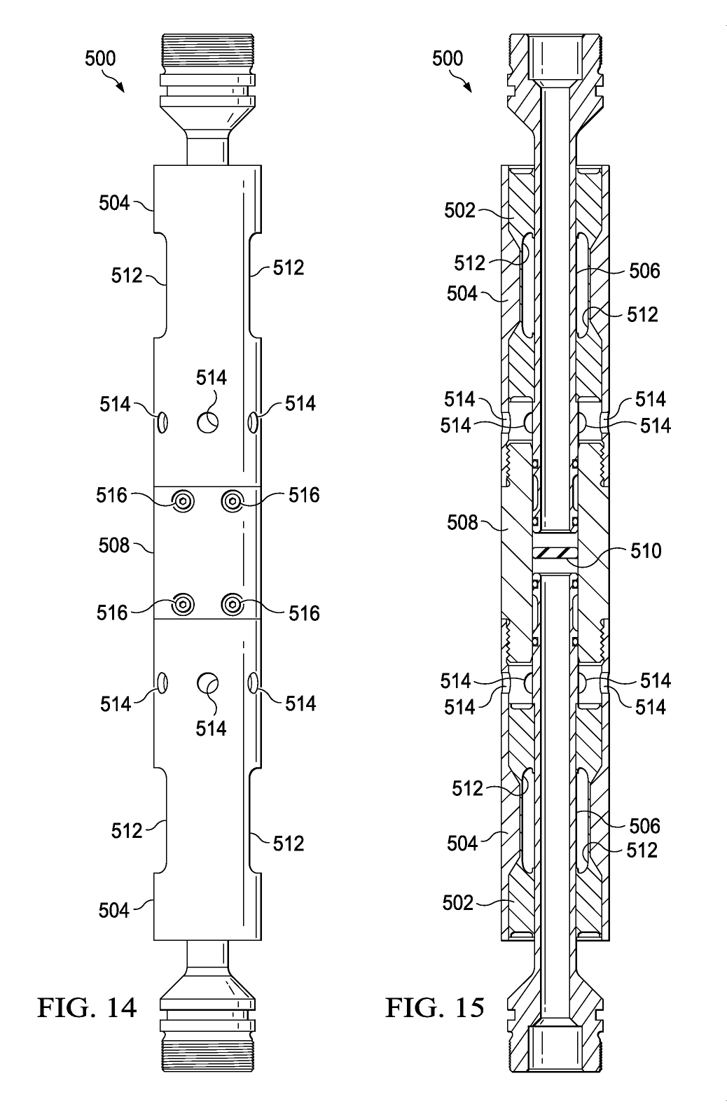

Referring now to FIG. 14, an orthogonal side view and an orthogonal side cut-away view of an alternative embodiment of an isolator 500 are shown. The isolator 500 is substantially similar to the isolator 200 insofar as the isolator 500 generally comprises two shear units 502 adhered between sleeves 504 and mandrels 506. Each of the sleeves 504 is joined to a central joint 508. In this embodiment, an elastomeric bumper 510 is disposed within the central joint 508 to prevent contact between the mandrels 506. In this embodiment, the sleeves 504 comprise slots 512 and apertures 514 configured to allow external fluids to act equally against the mandrels 506 and the shear units 502, thereby preventing a tendency for high fluid pressure to displace the mandrels 506. In some cases, an input of 1 unit of distance (i.e. an overall shortening of the isolator 500 by 1 unit of distance) may result in substantially one half a unit of translation of an input mandrel 506′ relative to the sleeve 504 through which it passes and the central joint 508. In some cases, substantially the remaining one half unit of translation may be achieved by translating the sleeves 504 and central joint 508 one half unit of translation closer to the remaining or output end of the opposite mandrel 506″. Bolts 516 may be used to capture the mandrels 506 relative to the central joint 508. In some embodiments, an electrical bulkhead connection may be provided on an end of a mandrel and/or any other end piece of the isolator 500. Alternatively, electrical wiring and/or a wiring harness may be connected between end pieces of the isolator 500 so that the electrical wiring is relatively more straightened longitudinally when the isolator 500 comprises its greatest longitudinal length as compared to when the isolator 500 is compressed to comprise a shorter overall length.

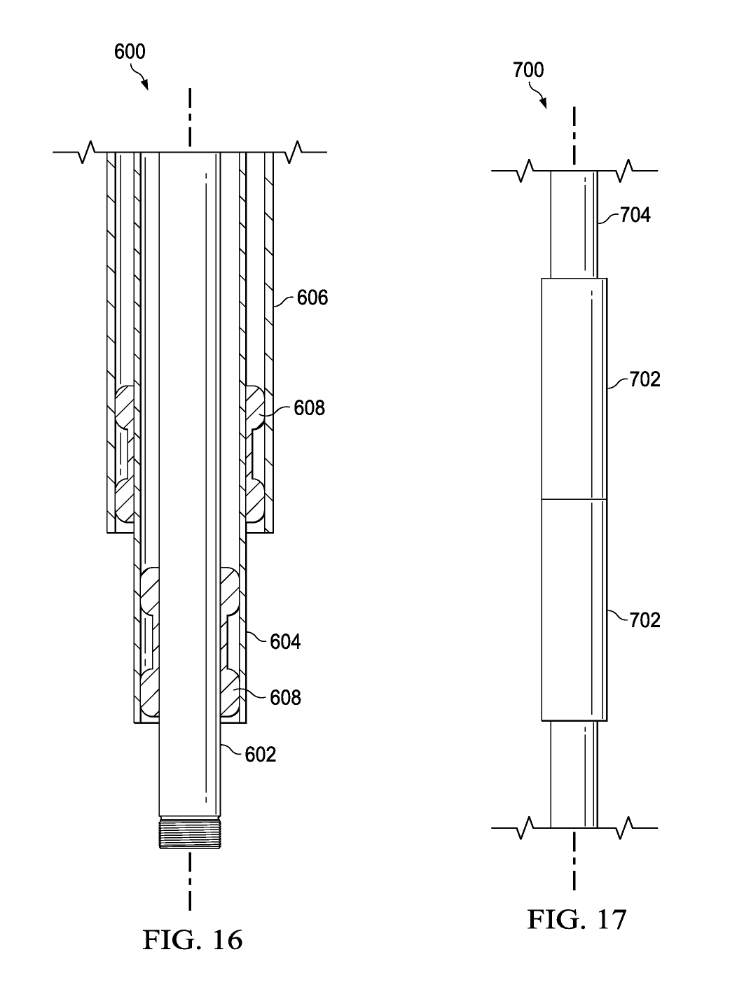

FIG. 16 is a schematic cut-away side view of an isolator 600 according to another embodiment of the disclosure. The isolator 600 may comprise an input tube 602 located concentrically within an intermediate tube 604 and the intermediate tube 604 may be located concentrically within an outer tube 606. The concentrically located tubes 602, 604, 606 may be separated from each other by shear units 608 substantially similar to shear units 218. In some cases, the shear units 608 may provide a force transmission path extending through the two shear units 608 that may be connected to each other as springs in series. In some embodiments, the stiffness and other qualities of the shear units 608 may be selected so that a single unit of input displacement is substantially evenly accommodated by each of the shear units 608. In some embodiments, the input force may transfer from the input tube 602 to the intermediate tube 604 via a shear unit 608 and from the intermediate tube 604 to the outer tube 604 by another shear unit 608. In some cases, the isolator may tend to collapse and/or nest to shorten in overall length in response to the input force.

FIG. 17 is a schematic view of a hydrocarbon recovery system 700 according to an alternative embodiment of the disclosure. In this embodiment, the hydrocarbon recovery system comprises two isolators 702 connected to each other in series along the drill string 704. In some embodiments, one or more of the isolator 702 components may comprise metal, such as, but not limited to, stainless steel.

While isolators 200, 500, 600, 702 are disclosed as comprising force paths that transfer forces via shearing action of two shear units 218, 502, 608, 702, in alternative embodiments, the force paths may comprise additional shear units 218, 502, 608, 702 configured to pass the force through more than two shear units 218, 502, 608, 702 in series with each other. While the above-described isolators 200, 500, 600, 702 are disclosed as achieving substantially equal displacement attribution to each of the shear units 218, 502, 608, 702, this disclosure contemplates that the shear units 218, 502, 608, 702 of a single force path may serve as an energy sink so that vibratory and/or shock waves that are second or later to receive the waves may displace slightly less than a primary or previous shear unit 218, 502, 608, 702.

In some embodiments, an isolator, such as isolator 218, comprises a force input component, such as lower mandrel 216″ and/or any combination of components substantially rigidly connected to the mandrel 216″ (i.e. lower adapter 212). In some embodiments, an isolator may comprise a force output component, such as upper mandrel 216′ and/or any combination of components substantially rigidly connected to the upper mandrel 216′ (i.e. upper adapter 204). In some embodiments, a drill string such as drill string 102 may comprise a first excitation force source component, such as drill bit 106 that may generate vibratory forces and/or shock forces in response to operation of the drill bit 106 and/or in response to the drill bit 106 encountering hard formations.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Unless otherwise stated, the term “about” shall mean plus or minus 10 percent of the subsequent value. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention.

What is claimed is:

1. An isolator, comprising:
a force input component;
a force output component;
a first shear unit connected between the force input component; and
a second shear unit connected between the force output component;
wherein the first shear unit and the second shear unit are connected in series with each other along a force path between the force input component and the force output component.

2. The isolator of claim 1, wherein the first shear unit comprises an elastomer.

3. The isolator of claim 1, wherein the first shear unit comprises at least one of rubber and nitrile.

4. The isolator of claim 1, further comprising:
a first sleeve connected between the first shear unit and the second shear unit.

5. The isolator of claim 4, wherein the first sleeve comprises a tubular wall comprising an aperture configured to substantially equalize a fluid pressure within the first sleeve relative to a fluid pressure outside of the first sleeve.

6. The isolator of claim 4, wherein the force input component and the first sleeve are substantially coaxially aligned and wherein the force input component is restricted from axial rotation relative to the first sleeve component.

7. The isolator of claim 4, wherein the first shear unit is adhered to the first sleeve.

8. The isolator of claim 7, wherein the force input component comprises a first mandrel.

9. The isolator of claim 8, wherein the first shear unit is adhered to the first mandrel.

10. The isolator of claim 1, wherein the first shear unit is substantially similar to the second shear unit.

11. A hydrocarbon recovery system, comprising:
a first isolated mass;
a first excitation force source component; and
a first isolator disposed between the first isolated mass and the first excitation force source component, the first isolator comprising:
a force input component;
a force output component;
a first shear unit connected between the force input component and the force output component; and
a second shear unit connected between the force input component and the force output component;
wherein the first shear unit and the second shear unit are connected in series with each other along a force path between the force input component and the force output component.

12. The hydrocarbon recovery system of claim 11, wherein the first isolated mass comprises at lease one of a measurement while drilling (MWD) component and a log while drilling (LWD) component.

13. The hydrocarbon recovery system of claim 11, wherein the first excitation force source component comprises at least one of an agitator and a drill bit.

14. The hydrocarbon recovery system of claim 11, wherein the first isolator comprises a variable overall length.

15. The hydrocarbon recovery system of claim 11, wherein a natural frequency of a spring mass system comprising at least the first isolator and the first isolated mass is less than a vibratory frequency generated by the first excitation force source component such that the transmissibility at the excitation frequency is less than 1.0.

16. The hydrocarbon recovery system of claim 11, further comprising a second isolator substantially similar to the first isolator.

17. The hydrocarbon recovery system of claim 16, wherein the second isolator is connected between the first isolated mass and the first excitation force source component and adjacent the first isolator.

18. The hydrocarbon recovery system of claim 11, wherein a natural frequency of a spring mass system comprising at least the first isolated mass is less than prevalent shock frequencies such that a maximum shock amplification factor associated with the prevalent shock frequencies is less than 1.0.

19. A method of isolating a component, comprising:
selecting an excitation frequency associated with operation of a first excitation force source component;
providing a spring mass system comprising a first isolated mass and an isolator, the spring mass system comprising a natural frequency less than the selected excitation frequency; and
disposing the isolator between the isolated mass and the first excitation force source component.

20. The method of claim 19, wherein the selected excitation frequency is equal to a value of between about 10 Hz to 20 Hz.

21. The method of claim 19, wherein the selected excitation frequency is equal to a value of between about 20 Hz to 100 Hz

22. The method of claim 19, further comprising:
isolating the first isolated mass from the first excitation force source component by at least one of shortening and lengthening an overall length of the isolator.

23. The method of claim 22, wherein the change in overall length is substantially attributable to (1) shearing a first shear unit to produce a first portion of change in overall length and to (2) shearing a second shear unit to produce a second portion of change in overall length, wherein the second portion of change in overall length is substantially equal to the first portion of change in overall length.

24. The method of claim 23, wherein at least one of the first shear unit and the second shear unit comprises at least one of rubber and nitrile.

25. The method of claim 22, wherein the first shear unit comprises a first tubular shear element disposed between a first mandrel and a first sleeve and a second tubular shear element disposed between the first mandrel and the first sleeve, and wherein the first tubular shear element is longitudinally offset from the second tubular shear element by an offset distance selected to reduce off axis cocking of the first mandrel relative to the first sleeve.

26. The method of claim 22, wherein when the isolator is in tension and comprises a maximum overall length, the isolator remains intact as a unit thereby allowing removal from a wellbore via fishing techniques.
